(19) United States
(12) Patent Application Publication
(10) Pub. No.: US 2012/0179883 A1
(43) Pub. Date: Jul. 12, 2012

(54) System and method for dynamically adjusting memory performance

(75) Inventor: Kenneth Ma, Cupertino, CA (US)

(73) Assignee: BROADCOM CORPOTATION, IRVINE, CA (US)

(21) Appl. No.: 12/931,256

(22) Filed: Jan. 24, 2011

Related U.S. Application Data
(60) Provisional application No. 61/431,999, filed on Jan. 12, 2011.

(51) Int. Cl. G06F 12/00

(52) U.S. Cl. 711/157; 711/E12.001

(57) ABSTRACT

According to an exemplary embodiment, a method for dynamically adjusting memory performance includes detecting a bandwidth of a data transfer. Detecting the bandwidth can comprise measuring a data stream of the data transfer and determining the bandwidth based on the measuring. The method further includes selecting a subset of a plurality of interleaved memory units based on the bandwidth. A device performing the data transfer can comprise a power supply and the selecting can be based on a power level of the power supply. The selecting can also be based on a temperature of the device performing the data transfer. The method also includes performing a data access for the data transfer using the subset of the plurality of interleaved memory units.

The present application claims the benefit of and priority to a pending provisional patent application entitled “System and Method for Dynamically Adjusting Memory Performance,” Ser. No. 61/431,999 filed on Jan. 12, 2011. The disclosure in that pending provisional application is hereby incorporated fully by reference into the present application.

### BACKGROUND OF THE INVENTION

1. Field of the Invention

The present invention is generally in the field of data storage. More particularly, the invention relates to dynamic management of data storage.

2. Background Art

Flash memory, such as NAND and NOR flash memory, have become widely implemented in computer data storage. NAND flash memory, for example, can provide solid-state non-volatile data storage, which has been utilized in mass storage solutions, such as sold-state drives. However, flash memory die architectures, for example, single level cell (SLC) and multi-level cell (MLC) NAND die architectures, have technological constraints that limit flash memory performance. As specific examples, an SLC die can typically have read performance of less than 50 megabytes per second (MBps) and write performance of less than 25 MBps while an MLC die can typically have read performance of less than 25 MBps and write performance of less than 15 MBps.

The aforementioned limits of flash memory performance pose significant challenges in avoiding bottlenecks in data transfer systems. Next generation wired data transfer interfaces, for example, USB3.0, SD4.00, and JEDEC UFS can provide bandwidth upwards of 300 MBps and even wireless data transfer interfaces, such as 802.11ac and 802.11ad (WiGig), for example, may provide multi-gigabit per second (Gbps) performance with higher than 3 Gbps peak throughput. In order to increase performance of memory to, for example, avoid throughput bottlenecks in a data transfer system, the data transfer system may include multiple interleaved memory units. NAND flash memory can, for example, include multi-die, multi-channel, multi-plane interleaving to increase performance almost linearly with the number of dies.

However, because each interleaved memory unit operates in parallel during a data access for a data transfer, peak power and heat generated by a data transfer system can increase linearly with the number of memory units. The peak power and heat may exceed power and/or thermal budgets of a device hosting the interleaved memory units. For example, a battery can serve as a power supply in a mobile device, such as laptop, cellular phone, and the like. However, conventionally peak power can exceed a maximum power budget that the battery can support, resulting in failure of the data transfer system. Furthermore, components of the mobile device can be configured for compactness such that heat generated by the data transfer system can quickly result in unacceptably high temperatures in the mobile device, resulting in failure of the data transfer system.

Thus, there is a need in the art for systems and methods to provide for data transfer using interleaved memory units that can overcome drawbacks and deficiencies in the art.

### SUMMARY OF THE INVENTION

A system and method for dynamically adjusting memory performance, substantially as shown in and/or described in connection with at least one of the figures, as set forth more completely in the claims.

### BRIEF DESCRIPTION OF THE DRAWINGS

FIG. 1 illustrates an exemplary data transfer system, according to one embodiment of the invention.

FIG. 2 illustrates an exemplary data transfer system, according to one embodiment of the invention.

FIG. 3 illustrates exemplary tagged data streams, according to one embodiment of the invention.

FIG. 4 shows an exemplary flowchart presenting a method for dynamically adjusting memory performance, in accordance with one embodiment of the present invention.

### DETAILED DESCRIPTION OF THE INVENTION

The present invention is directed to a system and method for dynamically adjusting memory performance. The following description contains specific information pertaining to the implementation of the present invention. One skilled in the art will recognize that the present invention may be implemented in a manner different from that specifically discussed in the present application. Moreover, some of the specific details of the invention are not discussed in order to not obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

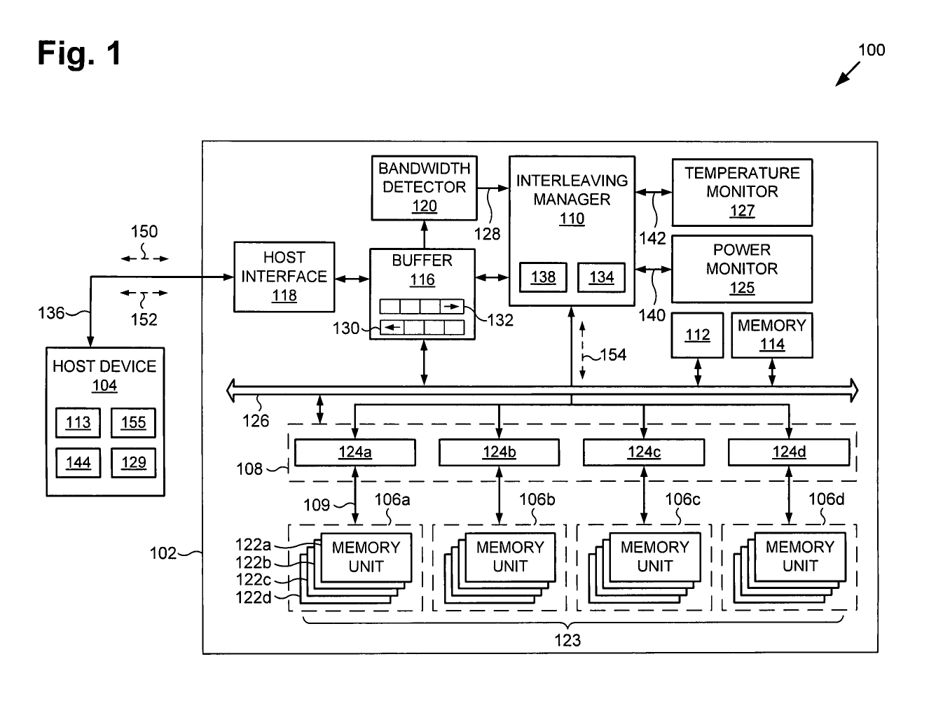

FIG. 1 illustrates data transfer system 100, according to one embodiment of the present invention. As shown in FIG. 1, data transfer system 100 includes memory device 102 and host device 104. Further shown in FIG. 1, host device 104 includes processor 113, bandwidth 129, battery 144, and executable machine code 155. Memory device 102 includes interleaved memory unit stacks 106a, 106b, 106c, and 106d (also referred to herein as interleaved memory unit stacks 106), interleaving controller 108, interleaving manager 110, microprocessor 112, memory 114, buffer 116, host interface 118, bandwidth detector 120, power monitor 125, and temperature monitor 127. Interleaving controller 108 comprises controllers 124a, 124b, 124c, and 124d (also referred to herein as controllers 124).

Memory device 102 can comprise, for example, one of a solid-state drive, a flash drive, and a Secure Digital (SD) Card. Host device 104 can comprise, for example, one of a mobile device, a personal computer, a wireless router, a digital camera, a video camera, and a recording device. Although memory device 102 is shown as being external to host device 104, in some embodiments, memory device 102 can be included in host device 104.

FIG. 1 shows interleaved memory unit stacks 106 of memory device 102 each comprising respective interleaved memory units, such as, interleaved memory units 122a, 122b, 122c, and 122d (also referred to herein as interleaved memory units 122), which collectively comprise plurality of interleaved memory units 123. In the present example, each interleaved memory unit stack 106 includes four interleaved memory units 122. However, in other embodiments each interleaved memory unit stack 106 can comprise a different number of interleaved memory units 122. Each of plurality of interleaved memory units 123 can comprise, for example, a flash memory die, such as a NAND flash memory die. For example, in some embodiments, interleaved memory unit 122a can comprise an MLC or SLC NAND flash memory die. Data transfer system 100 can comprise four-die interleaving, as a specific example. In some embodiments, each die can have multiple planes, for example two planes or four planes, which are not shown in FIG. 1.

In FIG. 1, memory device 102 is shown as having an exemplary system architecture, which can be used, for example, to implement plurality of interleaved memory units 123 in a solid-state drive, for example. FIG. 1 shows interleaved memory unit stacks 106 coupled to interleaving controller 108 and interleaving controller 108 coupled to interleaving manager 110 and bus 126. FIG. 1 also shows microprocessor 112, memory 114, and buffer 116 coupled to bus 126. The exemplary system architecture of FIG. 1 is not intended to limit the present invention. It will be appreciated that in some embodiments the functionality of a component shown as being discrete in FIG. 1 can be provided by one or more components or combined with other components. Furthermore, the components shown in FIG. 1 can be interconnected in arrangements different from the exemplary arrangement shown in FIG. 1.

In data transfer system 100, memory device 102 and host device 104 can perform data transfers 150 and 152, for example. In the present example, data transfers 150 and 152 are between plurality of interleaved memory units 123, in memory device 102, and host device 104 over connection 136. In some embodiments connection 136 is a wired connection. In other embodiments connection 136 is a wireless connection. Host interface 118 can comprise a bus interface of memory device 102 connecting to a controller. Host interface 118 can facilitate connection 136 between memory device 102 and host device 104. Host interface 118 can facilitate, for example, USB3.0, PCIe, JEDEC UFS, SD4.00, SATA, 802.11 ac, and 802.11 ad based interfaces as specific examples.

At least one of data transfers 150 and 152 can be, for example, a read transfer from plurality of interleaved memory units 123 to host device 104 comprising multiple data accesses 154, where each data access 154 is a read access. At least one of data transfers 150 and 152 can also be, for example, a write transfer from host device 104 to plurality of interleaved memory units 123 comprising multiple data accesses 154, where each data access 154 is a write access.

In the exemplary system architecture shown in FIG. 1, a data path for data transfers 150 and 152 can be along a path from host device 104 over connection 136 through host interface 118, buffer 116, interleaving manager 110, and controllers 124 to plurality of interleaved memory units 123. As noted above, other implementations are possible.

Memory device 102 includes microprocessor 112 and memory 114 to facilitate data transfers 150 and 152. Microprocessor 112 can operate with memory 114 in order to control buffer 116 and interleaving controller 108 to manage data transfers 150 and 152. It will be appreciated that in memory device 102, some or all of the functionality of microprocessor 112 can be shared with or provided by at least one logic unit. In the present embodiment, memory 114 can comprise local memory, such as random access memory (RAM), for example, dynamic random access memory (DRAM). It is noted that some or all of the functionality of memory 114 can be shared with or provided by at least one memory component, which can be other forms of memory, such as integrated memory on-die.

Memory device 102 further includes interleaving manager 110 to manage data transfers 150 and 152. In the present embodiment interleaving manager 110 includes configuration registers 138. Configuration registers 138 can control which of plurality of interleaved memory units 123 will be accessed in a subsequent data access 154 for data transfer 150 or 152. Configuration registers 138 can indicate that a set of plurality of interleaved memory units 123 will be accessed in the subsequent data access 154. The sets of plurality of interleaved memory units 123 available for data access 154 are specific to the implementation of interleaving controller 108. Interleaving controller 108 can then perform data access 154 to the set of plurality of interleaved memory units 123 indicated by configuration registers 138. In the present embodiment, interleaving manager 110 can manage multiple data transfers 150 and/or 152 simultaneously, and can perform one data access 154 at a time. It is noted that other embodiments can have different configurations.

In the present embodiment, interleaving controller 108 comprises controllers 124, which can each control a respective channel to perform data access 154 to plurality of interleaved memory units 123. For example, controller 124a can control channel 109, which is coupled to interleaved memory unit stack 106a. FIG. 1 shows four-channel interleaving, as a specific example. Furthermore, each controller 124 can control multiple ways to perform data access 154 to plurality of interleaved memory units 123. For example, controller 124a is separately coupled to each respective interleaved memory unit 122 (not shown in FIG. 1). Data transfer system 100 comprises four-channel four-way interleaving, as a specific example. In one exemplary implementation, each controller 124 can have four chip selects, each chip select connected to and controlling a respective one of plurality of interleaved memory units 123. The exemplary configuration described above can comprise multi-die, multi-channel, multi-way, multi-plane interleaving.

Also in data transfer system 100, interleaving manager 110 includes processor 134, which is configured to select a subset of plurality of interleaved memory units 123 for data access 154 for a respective data transfer 150 or 152 based on bandwidth 128 or 129 of the respective data transfer 150 or 152. In data transfer system 100, processor 134 can dynamically select the plurality of interleaved memory units 123 for each data access 154. For example, processor 134 can select a first set of plurality of interleaved memory units 123 for a first data access 154 for data transfer 150 and a different second set of plurality of interleaved memory units 123 for a second subsequent data access 154 for data transfer 150.

By dynamically selecting a subset of plurality of interleaved memory units 123 for data access 154 for, for example, data transfer 150, processor 134 can adapt and optimize interleaving of plurality of interleaved memory units 123 to changing conditions in data transfer system 100, such as temperature conditions and power supply conditions. Furthermore, by dynamically selecting based on, for example, bandwidth 128 for data transfer 150, processor 134 can account for bandwidth 128, which may be desirable for data transfer 150, while adapting and optimizing interleaving of plurality of interleaved memory units 123.

While in the present embodiment, processor 134 is shown as a discrete processor, in other embodiments the functionality of processor 134 can be shared with or provided by at least one logic unit, such as a microprocessor 112. Also in some embodiments, microprocessor 112 can have similar functionality as processor 134 and can modify configuration registers 138.

It is noted that in the present embodiment interleaving manager 110 can manage multiple simultaneous data transfers using plurality of interleaved memory units 123. As an example, data transfer system 100 can manage a write data transfer to plurality of interleaved memory units 123 from host device 104 and simultaneously manage a read data transfer from plurality of interleaved memory units 123 to host device 104. Furthermore, the read data transfer and the write data transfer can utilize different sets of plurality of interleaved memory units 123 for a data access, which can each be dynamically selected by processor 134 and can each be based on bandwidths of and for the respective data transfers. Furthermore, a data access for the read data transfer may be subsequent to a data access for the write data transfer, and vice versa.

FIG. 1 shows bandwidth detector 120, which is configured to detect bandwidth 128 for a data transfer, for example, data transfer 150 or 152. In one embodiment, bandwidth detector 120 is configured to perform a measurement of data stream 130 or 132 of a respective data transfer 150 or 152 and determine and/or calculate the bandwidth based on the measurement to detect the bandwidth of the respective data transfer 150 or 152. Bandwidth detector 120 can then provide bandwidth 128 to processor 134 and processor 134 can select a subset of plurality of interleaved memory units 123 for data access 154 for a respective data transfer 150 or 152 based on bandwidth 128.

Also in data transfer system 100, host device 104 includes processor 113, which can comprise, for example, a microprocessor, such as a central processing unit (CPU) of host device 104. Host device 104 also includes executable machine code 155, which can be executed by processor 113. For example, processor 113 can execute executable machine code 155 in order to manage data transfers 150 and 152. Executable machine code 155 can comprise, for example, firmware, operating system (OS) software, program software, or other types of executable machine code.

In some embodiments, processor 113 can comprise a bandwidth detector and can utilize executable machine code 155 to detect bandwidth 129 for data transfer 150 or data transfer 152. More particularly, executable machine code 155 can comprise machine code capable of detecting bandwidth 129 for data transfer 150 or data transfer 152, which will be described in more detail below. Bandwidth 129 can then be provided to processor 134. Processor 134 can then select a subset of plurality of interleaved memory units 123 for data access 154 for a respective data transfer 150 or 152 based on bandwidth 129. In some embodiments processor 113 can select a subset of plurality of interleaved memory units 123 for data access 154 for a respective data transfer 150 or 152 based on bandwidth 129 in addition to or instead of processor 134. In these embodiments, processor 113 in host device 104 may be capable of directly modifying configuration registers 138 and thus cause a set of plurality of interleaved memory units 123 to be accessed in a subsequent data access 154. In some embodiments bandwidth 129 can be determined during a data transfer by, for example, processor 113 using executable code 155, in other embodiments bandwidth 129 can be predetermined.

It is noted that in some embodiments, executable machine code 155 may not be configured to detect bandwidth 129 for data transfer 150 or data transfer 152. For example, bandwidth detector 120 may only be configured to detect bandwidth 128 for a data transfer, for example, data transfer 150 or 152 by measuring read data stream 130 or write data stream 132. Thus, methods in accordance with the present invention can be provided in data transfer system 100 without modification to conventional OS software and computer programs in host device 104. In these embodiments processor 113 may not be capable of modifying configuration registers 138.

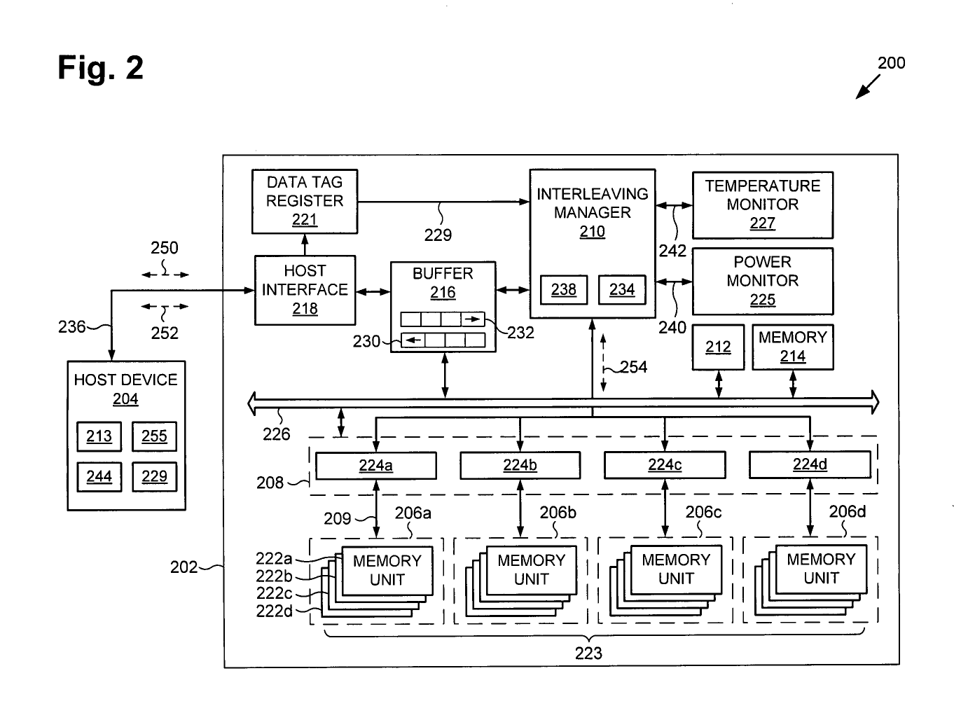

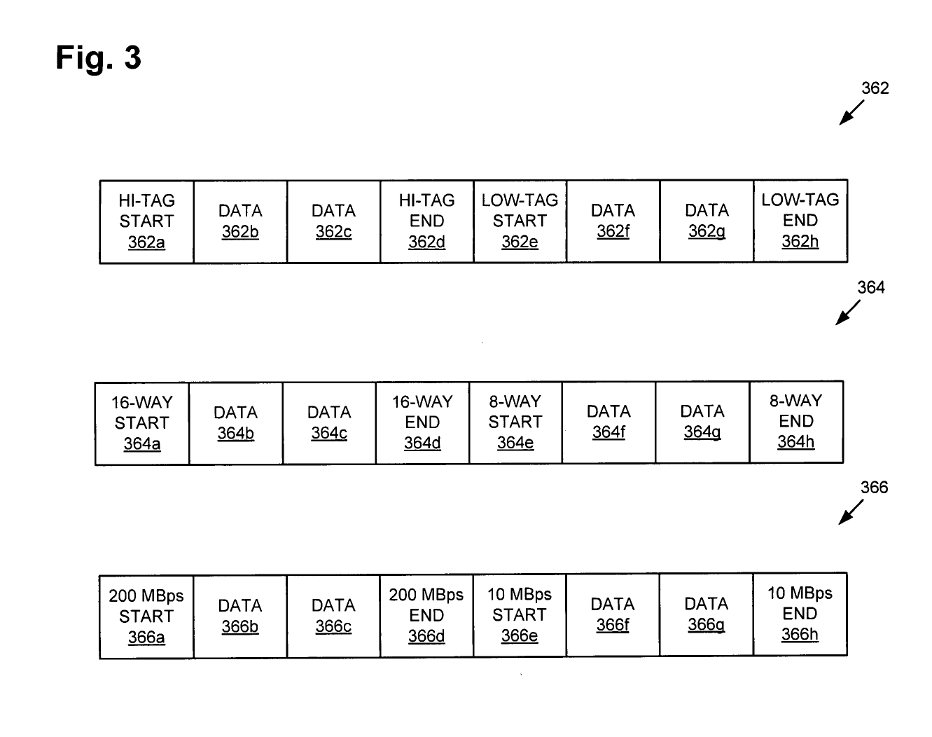

Referring now to FIGS. 2 and 3, FIG. 2 shows data transfer system 200, which can correspond to data transfer system 100 in FIG. 1. FIG. 3 shows tagged data streams 362, 364, and 366. In FIG. 2, data transfer system 200 includes memory device 202, host device 204, interleaved memory unit stacks 206a, 206b, 206c, and 206d (also referred to herein as interleaved memory unit stacks 206), interleaving controller 208, channel 209, interleaving manager 210, microprocessor 212, processor 213, memory 214, buffer 216, host interface 218, interleaved memory units 222a, 222b, 222c, and 222d (also referred to herein as interleaved memory units 222), plurality of interleaved memory units 223, power monitor 225, bus 226, temperature monitor 227, bandwidth 228, bandwidth 229, read data stream 230, write data stream 232, controllers 224a, 224b, 224c, and 224d (also referred to herein as controllers 224), processor 234, connection 236, configuration registers 238, power level 240, temperature level 242, battery 244, data transfers 250 and 252, and executable machine code 255, which can correspond respectively to memory device 102, host device 104, interleaved memory unit stacks 106a, 106b, 106c, and 106d (also referred to herein as interleaved memory unit stacks 106), interleaving controller 108, channel 109, interleaving manager 110, microprocessor 112, processor 113, memory 114, buffer 116, host interface 118, interleaved memory units 122a, 122b, 122c, and 122d (also referred to herein as interleaved memory units 122), plurality of interleaved memory units 123, power monitor 125, bus 126, temperature monitor 127, bandwidth 128, bandwidth 129, read data stream 130, write data stream 132, controllers 124a, 124b, 124c, and 124d (also referred to herein as controllers 124), processor 134, connection 136, configuration registers 138, power level 140, temperature level 142, battery 144, data transfers 150 and 152, and executable machine code 155 in FIG. 1.

In FIG. 2, host interface 218 is configured to extract bandwidth 229 as a data tag from any of tagged data streams 362, 364, and 366 of data transfer 250. The extracted data tag can be stored in data tag register 221 as shown in FIG. 2. It is noted while FIG. 2 shows data tag register 221 as external to interleaving manager 210, in some embodiments interleaving manager 210 can include data tag register 221. Bandwidth 229 can then be provided to processor 234 and processor 234 can select a subset of plurality of interleaved memory units 223 for data access 254 of data transfer 250 based on bandwidth 229. In some embodiments host interface 218 can remove the data tag from the tagged data stream. It will be appreciated that in the example shown, the format of bandwidth 229 can change between host device 204 and processor 234.

In FIG. 3, tagged data stream 362 comprises data tags 362a, 362d, 362e, and 362h and transfer data 362b, 362c, 362f, and 362g. Any of data tags 362a, 362d, 362e, and 362h can, for example, be extracted from tagged data stream 362 of data transfer 250 by host interface 218 as bandwidth 229 and stored in data tag register 221, as shown in FIG. 2. Bandwidth 229 can then be provided to processor 234 and processor 234 can select a subset of plurality of interleaved memory units 223 for data access 254 of data transfer 250 based on bandwidth 229. Tagged data stream 362 also comprises transfer data 362b, 362c, 362f, and 362g, which can correspond, for example, to untagged data in data transfer 250, which can be, for example, stored in a write to plurality of interleaved memory units 223. In some embodiments host interface 218 can also remove any of data tags 362a, 362d, 362e, and 362h from tagged data stream 362. Thus, in some embodiments, after data tags 362a, 362d, 362e, and 362h are removed from tagged data stream 362, tagged data stream 362 can correspond to data stream 132 in FIG. 1.

Also in FIG. 3, tagged data streams 364 and 366 can correspond to tagged data stream 362. Tagged data streams 362, 364, and 366 illustrate exemplary tagging methods for a data stream of, for example, data transfer 250. However, other tagging methods can be utilized. For example, in one embodiment a data tag can comprise control bits or flags in a header of data packets, which can be control or data packets. In tagged data stream 362, data tag 362a is a hi-tag start data tag, which corresponds to the start of a high range for data transfer 250, for example. As an example, processor 234 can be configured so that data tag 362a corresponds to bandwidth 228 for data transfer 250 being greater than or equal to 120 MBps, although other ranges or more ranges can be used. Data tag 362d is a hi-tag end indicator, which corresponds to the end of a high range bandwidth of data transfer 250, for example. Also in tagged data stream 362, data tag 362e is a low-tag start indicator, which corresponds to the start of a low range for data transfer 250, for example. As an example, processor 234 can be configured so that data tag 362e corresponds to bandwidth 228 for data transfer 250 being less than 120 MBps, although other ranges or more ranges can be used. Also in tagged data stream 362, data tag 362h is a low-tag end indicator, which corresponds to the end of a low range bandwidth of data transfer 250, for example.

In other embodiments, the data tag can refer to the number of ways plurality of interleaved memory units 223 should be interleaved. For example, processor 234 can be configured so that the number of ways in the data tag corresponds to a particular bandwidth of data transfer 250. FIG. 3 shows data tag 364a, which processor 234 can correspond to 16-way interleaving and 240 MBps bandwidth, for example. FIG. 3 also shows data tag 364e, which processor 234 can correspond to 8-way interleaving and 120 MBps bandwidth, for example. The data tag can also contain a bit rate value of bandwidth 228 as illustrated by tagged data stream 366. It is noted that some embodiments do not include a hi-tag end indicator, such as data tag 362d. For example, in data stream 362, data tag 362e can override data tag 362a without requiring data tag 362d. Similarly, some embodiments do not include 362h, 364d, 364h, 366d, and 366h. While data transfer system 200 is shown and described with respect to extracting a data tag from data transfer 250, it will be appreciated that in other embodiments a data tag can be extracted from data transfer 252 or other data transfers in data transfer system 200. Also, while FIG. 2 and data transfer system 200 has been described separately from FIG. 1, in some embodiments data transfer system 100 can include data tagging similar to data transfer system 200.

Utilizing data tags, such as data tag 362a in data transfer system 200, can allow data transfer system 200 to optimize bandwidth 229 of a respective data transfer 250 or 252. As an example, bandwidth detector 120 in FIG. 1 can measure data stream 132 of data transfer 150 to result in an estimated bandwidth 128 desirable for data transfer 150, which can be associated with a particular application running, for example, as executable code 155 on host device 104. However, in data transfer system 200, by utilizing tagged data streams, a particular application running, for example, as executable code 255 on host device 204, can communicate bandwidth 229, which is desirable for data transfer 150 to processor 234. It is noted that in some embodiments host device 204 can generate the data tags in the data stream, using for example, processor 213 and executable code 255. For example, executable machine code 255 can be configured to detect bandwidth 229 for data transfer 250 and can insert bandwidth 229 into a data stream. In some embodiments bandwidth 229 can be determined during a data transfer by, for example, processor 213 using executable code 255, in other embodiments bandwidth 229 can be predetermined.

Furthermore, utilizing data tags, such as data tag 362a in data transfer system 200, can allow data transfer system 200 to optimize bandwidth 229 of a respective data transfer 250 or 252 without requiring significant modification to, for example, conventional OS software, firmware, and computer programs in host device 204. For example, as described above, in some embodiments processor 213 can directly modify configuration registers 238 and thus cause a set of plurality of interleaved memory units 223 to be accessed in a subsequent data access 254. However, in that case, host device 204 is configured specifically to modify configuration registers 238, which may vary in other memory devices 202 that can be connected to host device 204. However, when utilizing data tags, host device 204 does not require knowledge of a specific implementation of configuration registers 238 in memory device 202.

Referring again to FIG. 1, in data transfer system 100, processor 134 is configured to select a subset of plurality of interleaved memory units 123 for data access 154 for a respective data transfer 150 or 152 based power level 140 of battery 144 in host device 104. For example, FIG. 1 shows power monitor 125, which is configured to monitor the status of a power supply utilized to perform, for example, data transfer 150. For example, power monitor 125 can comprise a battery status monitor configured to monitor the status of battery 144, which is utilized in data transfer system 100 to perform data transfers 150 and 152. As an example, in some embodiments, power monitor 125 can receive a battery status comprising a voltage measurement of battery 144 and can provide the measurement to processor 134 as power level 140. In some embodiments the battery status can comprise, for example, a high voltage status for battery 144 or a low voltage status for battery 144. Processor 134 can select a subset of plurality of interleaved memory units 123 for data access 154 for a respective data transfer 150 or 152 based on power level 140.

In data transfer system 100, the power required to perform each data access 154 on plurality of interleaving units 123 increases almost linearly with the number of plurality of interleaving units 123 accessed in each data access 154. As battery 144 can only supply so much power for each data access 154, utilizing an excess of plurality of interleaved units 123 can reduce the power available for battery 144 to supply to the remainder of host device 104 and can result in a system failure. However, by minimizing or reducing the subset of plurality of interleaved memory units 123, each data access 154 can require less power thereby freeing additional power for battery 144 to supply to the remainder of host device 104. Furthermore, battery 144 can be depleted and unable to supply enough power to perform data access 154 on plurality of interleaving units 123, resulting in a system failure. However, by minimizing or reducing the subset of plurality of interleaved memory units 123, each data access 154 can require less power thereby reducing the risk that battery 144 is unable to supply enough power to perform data access 154.

Also in data transfer system 100, processor 134 is configured to select a subset of plurality of interleaved memory units 123 for data access 154 for a respective data transfer 150 or 152 based temperature level 142 of memory device 102 and/or host device 104. For example, FIG. 1 shows temperature monitor 127, which is configured to monitor a temperature in memory device 102 and/or host device 104. Temperature monitor 227 can then provide temperature level 142 to processor 134. Processor 134 can then select a subset of plurality of interleaved memory units 123 for data access 154 for a respective data transfer 150 or 152 based on temperature level 142. In some embodiments temperature level 142 is a composite of multiple temperature measurements or temperature statuses from different sensors throughout memory device 102 and/or host device 104.

Temperature level 142 corresponds to a temperature in memory device 102 and/or host device 104 that is affected by the amount of interleaving used in data access 154. In memory device 102, the heat generated by performing each data access 154 on plurality of interleaving units 123 increases almost linearly with the number of plurality of interleaving units 123 accessed in each data access 154. As memory device 102 can be included in host device 104, the heat generated can cause unacceptably high temperatures in host device 104. However, by minimizing or reducing the subset of plurality of interleaved memory units 123, temperature level 142 can be reduced, thereby reducing the chance of thermal related failures in memory device 102 and host device 104.

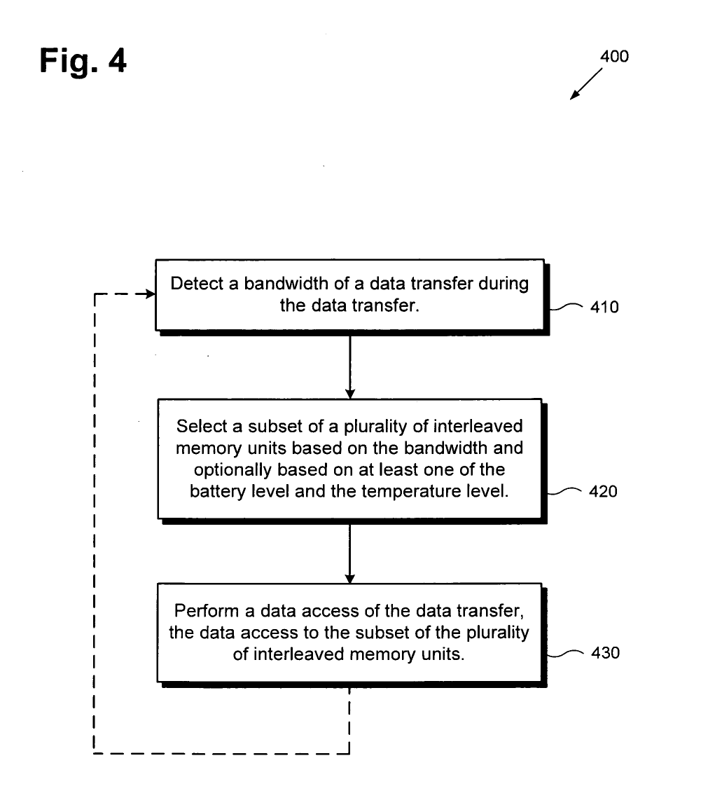

Referring now to FIG. 4, FIG. 4 shows exemplary flowchart 400 describing the steps, by which a data transfer system can dynamically adjust memory performance, according to one embodiment of the present invention. Certain details and features have been left out of flowchart 400 that are apparent to a person of ordinary skill in the art. For example, a step may comprise one or more substeps or may involve specialized equipment or materials, as known in the art. While steps 410 through 430 indicated in flowchart 400 are sufficient to describe one embodiment of the present invention, other embodiments of the invention may utilize steps different from those shown in flowchart 400.

Referring to step 410 of flowchart 400 in FIG. 4 and FIGS. 1, 2, and 3, step 410 of flowchart 400 comprises detecting a bandwidth of a data transfer. In some embodiments the bandwidth can be detected during the data transfer. In some embodiments the bandwidth can be detected prior to the data transfer. The detection in accordance with the present invention can be implemented using hardware, software, or a combination thereof.

Referring to data transfer system 100, in one embodiment bandwidth detector 120 can detect bandwidth 128 for data transfer 150 or for data transfer 152. For example, bandwidth detector 120 can detect bandwidth 128 by measuring read data stream 130 or write data stream 132 of a respective data transfer 150 or 152 to obtain a measurement. Bandwidth detector 120 can then determine bandwidth 128 based on the measurement. As an example, data transfer system 100 can perform part of data transfer 150 using all of plurality of interleaved memory units 123 and bandwidth detector 120 can determine that data transfer 150 requires 200 MBps by measuring data stream 130. Subsequently bandwidth detector 128 can provide bandwidth 128 to interleaving manager 110 as shown in FIG. 1.

In one embodiment, bandwidth detector 120 can detect bandwidth 128 comprising a write bandwidth of data transfer 150 or 152 by measuring data stream 132 to determine a receive rate of buffer 116. Furthermore, bandwidth detector 120 can detect bandwidth 128 comprising a read bandwidth of data transfer 150 or 152 by measuring data stream 130 to determine a transmit rate of buffer 116. For example, in the present embodiment, buffer 116 can comprise a first in first out (FIFO) input/output manager. Bandwidth detector 120 can be connected to buffer 116, for example across buffer 116, to measure fill and/or consume rates of buffer 116. In one embodiment, bandwidth detector 120 can detect bandwidth 128 for data transfer 150 or 152 by determining an average of the fill or consume rate of buffer 116 over a rolling window of time. The average can be provided to processor 134 as bandwidth 128. Thus, in some embodiments, bandwidth detector 120 can detect bandwidth 128 and can provide bandwidth 128 to processor 134 in real-time. Although not shown in FIG. 1, buffer 116 can comprise a memory buffer, for example, a discrete or embedded static random access memory (SRAM) or a synchronous dynamic random access memory (SDRAM) buffer.

As an example, data transfer system 100 can perform data transfer 150 utilizing all of plurality of interleaved memory units 123 in a plurality of data accesses 154. During data transfer 150, bandwidth detector 120 can measure the fill rate of buffer 116 to determine bandwidth 128, which corresponds to the bandwidth being utilized during data transfer 150. In step 420, utilizing bandwidth 128, processor 134 can then select less than all of plurality of interleaved memory units 123 in a subsequent data access 154, for example, a minimum set of plurality of interleaved memory units 123 that can still support bandwidth 128.

Also in data transfer system 100, in some embodiments processor 113 can utilize executable machine code 155 to detect bandwidth 129 for data transfer 150 or data transfer 152. More particularly, executable machine code 155 comprises machine code capable of detecting bandwidth 129 for data transfer 150 or data transfer 152. In the embodiment shown in FIG. 1, data transfer system 100 comprises microprocessor 113 for running executable machine code 155 to detect bandwidth 129 for data transfer 150 or data transfer 152. In some embodiments bandwidth 129 can be determined and/or calculated by executable machine code 155 during data transfer 150 or data transfer 152 to detect bandwidth 129. In some embodiments bandwidth 129 can be stored in host device 104 prior to data transfer 150 or data transfer 152. As one example, using executable code 155, processor 113 can determine that data transfer 150 is for a movie playback and detect a bit-rate comprising bandwidth 128 to maintain the quality of playback. It will be appreciated that bandwidth 128 can be detected many ways utilizing executable machine code 155, such as by reading bandwidth 128 from a data file.

It is noted that in some embodiments, executable machine code 155 cannot detect bandwidth 129 for data transfer 150 or data transfer 152 and bandwidth detector 120 can detect bandwidth 128 for data transfer 150 or for data transfer 152. In other embodiments, executable machine code 155 can detect bandwidth 129 for data transfer 150 or data transfer 152 and bandwidth detector 120 cannot detect bandwidth 128 for data transfer 150 or for data transfer 152. Still in other embodiments, executable machine code 155 can detect bandwidth 129 for data transfer 150 or data transfer 152 and bandwidth detector 120 can also detect bandwidth 128 for data transfer 150 or for data transfer 152.

Referring to data transfer system 200 and FIGS. 2 and 3, in one embodiment, detecting a bandwidth of a data transfer comprises extracting the bandwidth as a data tag from a data stream, for example, from a data stream of the data transfer. In one embodiment, bandwidth 229 can be extracted from host interface 218 as a data tag from, for example, any of data streams 362, 364, and 362 shown in FIG. 3. For example, bandwidth 229 can be extracted as any of data tags 362a, 362d, 362e, 362h, 364a, 364d, 364e, 364h, 366a, 366d, 366e, and 366h to data tag register 221. Bandwidth 229 can then be provided to interface manager 210 as shown in FIG. 2. In some embodiments data transfer system 200 is configured to remove the data tag from the data stream. Thus, the data tag may not reach plurality of interleaved memory units 123. As a specific example, data tags 362a, 362d, 362e, and 362h can be removed from data stream 362 so that data tags 362a, 362d, 362e, and 362h are not in data stream 230, shown in FIG. 2.

Also in data transfer system 200, in some embodiments processor 213 can utilize executable machine code 255 to detect bandwidth 229 for data transfer 250 or data transfer 252, similar to what has been described above with respect to FIG. 1. Furthermore, according to various embodiments of the present invention, a data transfer system may include any combination of the aforementioned detection methods either exclusively or in combination.

Referring to step 420 of flowchart 400 in FIG. 4 and FIGS. 1, 2, and 3, step 420 of flowchart 400 comprises selecting a subset of a plurality of interleaved memory units based on the bandwidth and optionally based on at least one of a battery level and a temperature level. For example, in one embodiment, processor 134 can select a subset of a plurality of interleaved memory units 123 based on bandwidth 128 and optionally based on at least one of power level 140 and temperature level 142. The selected subset of plurality of interleaved memory units 123 can then be stored in configuration registers 138. In one embodiment, processor 113 can select a subset of a plurality of interleaved memory units 123 based on bandwidth 129 and optionally based on at least one of power level 140 and temperature level 142. In some embodiments, processor 113 can then directly modify configuration registers 138 independently from processor 134.

In one embodiment, the subset of the plurality of interleaved memory units selected based the bandwidth can be the minimum subset of the plurality of interleaved memory units that can support the bandwidth. In one embodiment, selecting the subset of the plurality of interleaved memory units based the bandwidth comprises determining and/or calculating the minimum subset of the plurality of interleaved memory units that can support the bandwidth. As an example, in one embodiment, selecting the subset of plurality of interleaved memory units 123 based bandwidth 128 comprises processor 134 determining the minimum subset of plurality of interleaved memory units 123 that can support bandwidth 128.

In one embodiment, the subset of the plurality of interleaved memory units can be selected based on, a criticality of supporting the bandwidth in the data access. For example, processor 134 can determine the criticality of supporting bandwidth 128 in data access 154 and can select the subset of the plurality of interleaved memory units 123 based on the criticality. In one embodiment, the subset of the plurality of interleaved memory units can be selected based on a first bandwidth of a first data transfer and based on a second bandwidth of a second data transfer, for example, based on the criticality of supporting the first bandwidth and/or the second bandwidth in a respective data access. For example, processor 134 can select a subset of a plurality of interleaved memory units 123 based on, for example, a first bandwidth 128 for data transfer 150 and also a second bandwidth 128 for data transfer 152, for example, based on the criticality of supporting the first bandwidth 128 and the second bandwidth 128 in respective data accesses 154, which can each be determined by processor 134.

As a specific example, data transfer 150 can be a write transfer of sideloading from host device 104, comprising a mobile device, to plurality of interleaved memory units 123 in memory device 102, comprising a solid-state drive. Data transfer 152 can be a read transfer of memory device 102 comprising playing a movie on host device 104 from plurality of interleaved memory units 123. Furthermore, data transfer 150 and 152 may be managed simultaneously in data transfer system 100, as described above. In this example, processor 134 can determine that the first bandwidth 128 for data transfer 150 is not critical and can safely be reduced. For example, processor 134 can select a reduced subset of plurality of interleaved memory units 123 for data access 154 that cannot support the first bandwidth 128 because reducing performance for sideloading from host device 104 is not critical. Processor 134 can also determine that the second bandwidth 128 for data transfer 152 is critical and cannot safely be reduced. For example, processor 134 can select the subset of plurality of interleaved memory units 123 for data access 154 to support the second bandwidth 128 because reducing performance can degrade movie playback. The criticality of supporting bandwidth 128 can be determined, for example, by processor 134 or 113.

A specific example of step 410 is described below. It will be appreciated that certain details are used to illustrate more general inventive concepts. The example provided below assumes that each of plurality of interleaved memory units 123 comprise MLC NAND die supporting 25 MBps read transfer bandwidth and 15 MBps write transfer bandwidth. Furthermore, in this specific example, the performance of data transfer system 100 scales linearly based on each additional channel and each additional way used for each data access 154. For example, data transfer system 100 can support 4-channel and 4-way data access for 16× performance, 2-channel and 4-way data access for 8× performance, 1-channel and 4-way data access for 4× performance, and 1-channel and 2-way data access for 2× performance.

It is noted that in the present example, the performance multipliers listed above correspond to the number of plurality of interleaved memory units 123 used in each data access 154. Thus, for a read data transfer, 16× performance supports a read bandwidth of 400 MBps, 8× performance supports a read bandwidth of 200 MBps, 4× performance supports a read bandwidth of 100 MBps, and 2× performance supports a read bandwidth of 50 MBps. Similarly, for a write data transfer, 16× performance supports a write bandwidth of 240 MBps, 8× performance supports a write bandwidth of 120 MBps, 4× performance supports a write bandwidth of 60 MBps, and 2× performance supports a write bandwidth of 30 MBps

In one example, data transfer 150 can be a write transfer of sideloading from host device 104, comprising a mobile phone, to plurality of interleaved memory units 123 in memory device 102. Data transfer 152 can be a read transfer of memory device 102 comprising playing a movie on host device 104 from plurality of interleaved memory units 123. During data transfer 150, bandwidth detector 120 can measure write data stream 132 of data transfer 150 and calculate bandwidth 128 as 150 MBps. During data transfer 152, bandwidth detector 120 can measure read data stream 130 of data transfer 150 and calculate bandwidth 128 as 5 MBps.

Processor 134 can then select a subset of plurality of interleaved memory units 123 based on bandwidth 128. For example, processor 134 can determine that data transfer system 100 requires at least 8× performance (200 MBps) to support bandwidth 128 comprising 150 MBps for data transfer 150, which corresponds to eight plurality of interleaved memory units for each data access 154 in the present example. Thus, processor 134 can select the subset of plurality of interleaved memory units 123 based on bandwidth 128 by determining a minimum subset of plurality of interleaved memory units 123 that can support bandwidth 128 for data transfer 150. As noted above, in this specific example, the minimum subset of plurality of interleaved memory units 123 includes eight plurality of interleaved memory units 123. However, it will be appreciated that processor 134 can select more than the minimum subset of plurality of interleaved memory units 123.

Similarly, processor 134 can determine that data transfer system 100 requires only 1× performance (15 MBps) to support bandwidth 128 comprising 5 MBps for data transfer 152, which corresponds to one of plurality of interleaved memory units for each data access 154 in the present example. Thus, processor 134 can select the subset of plurality of interleaved memory units 123 based on bandwidth 128 by determining a minimum subset of plurality of interleaved memory units 123 that can support bandwidth 128 for data transfer 152. As noted above, in this specific example, the minimum subset of plurality of interleaved memory units 123 includes one of plurality of interleaved memory units 123.

As a modification to the above example, processor 134 may determine that temperature level 142 is above a threshold temperature level or is at a high temperature level. Processor 134 can determine that supporting bandwidth 128 for data transfer 150 in data access 154 is not critical because data transfer 150 is a sideloading of a data file, as discussed above. Thus, processor 134 can select less than the minimum subset of plurality of interleaved memory units 123 that can support bandwidth 128 for data transfer 150. Furthermore, because in the present example, it is critical to support bandwidth 128 for data transfer 152, processor 134 may select the subset of plurality of interleaved memory units 123 based on bandwidth 128 as at least a minimum subset of plurality of interleaved memory units 123 that can support bandwidth 128 for data transfer 152. Similar selections as described above can be made based on processor 134 determining that power level 140 is below a threshold power level or is at a low power level.

Referring to step 430 of flowchart 400 in FIG. 4 and FIGS. 1, 2, and 3, step 430 of flowchart 400 comprises performing a data access for the data transfer using the subset of the plurality of interleaved memory units. For example, in data transfer system 100, interleaving controller 108 can perform data access 154 for data transfer 150 or 152 using the subset of the plurality of interleaved memory units 123 stored, for example, in configuration registers 138. As indicated in FIG. 4, steps 410 through 430 can be repeated throughout a data transfer. In some embodiments only steps 420 and 430 may be repeated throughout a data transfer.

Thus, as discussed above, in the embodiments of FIGS. 1 through 4, the invention can provide for a system and method for dynamically adjusting memory performance. By dynamically adjusting memory performance, embodiments of the present invention can adapt and optimize interleaving for data transfers to changing conditions in data transfer systems. Furthermore, various embodiments of the present invention can provide for adapting and optimizing interleaving for the data transfers while taking into account bandwidths desirable for the data transfers as well as power levels and temperature levels in the data transfer system.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

1. A method for dynamically adjusting memory performance, said method comprising:
detecting a bandwidth of a data transfer;
selecting a subset of a plurality of interleaved memory units based on said bandwidth;
performing a data access for said data transfer using said subset of said plurality of interleaved memory units.

2. The method of claim 1, wherein said detecting said bandwidth comprises measuring a data stream of said data transfer.

3. The method of claim 2, wherein said detecting said bandwidth comprises determining said bandwidth based on said measuring.

4. The method of claim 1, wherein said detecting said bandwidth comprises extracting said bandwidth as a data tag from a data stream.

5. The method of claim 1, wherein said detecting said bandwidth comprises executing machine code.

6. The method of claim 1, wherein a device performing said data transfer comprises a power supply, and wherein said selecting is based on a power level of said power supply.

7. The method of claim 1, wherein said selecting is based on a temperature of a device performing said data transfer.

8. The method of claim 1, wherein said subset of said plurality of interleaved memory units is a minimum subset of said plurality of interleaved memory units that can support said bandwidth.

9. The method of claim 1, wherein said plurality of interleaved memory units comprise flash memory units.

10. The method of claim 1, wherein said plurality of interleaved memory units comprise NAND flash memory units.

11. A system for dynamically adjusting memory performance, said system comprising:
a bandwidth detector configured to detect a bandwidth of a data transfer;
a processor configured to select a subset of a plurality of interleaved memory units based on said bandwidth;
a memory controller configured to perform a data access for said data transfer using said subset of said plurality of interleaved memory units.

12. The data transfer system of claim 11, wherein said bandwidth detector comprises a bandwidth detector, said bandwidth detector performing a measurement of a data stream of said data transfer.

13. The data transfer system of claim 12, wherein said bandwidth detector determines said bandwidth based on said measurement.

14. The data transfer system of claim 11, wherein said bandwidth detector detects said bandwidth by extracting a data tag from a data stream.

15. The data transfer system of claim 11, wherein said bandwidth detector comprises executable machine code.

16. The data transfer system of claim 11, wherein data transfer system comprises a power supply, and wherein said processor selects said subset of said plurality of interleaved memory units based on a power level of said power supply.

17. The data transfer system of claim 11, wherein said processor selects said subset of said plurality of interleaved memory units based on a temperature of said data transfer system.

18. The data transfer system of claim 11, wherein said subset of said plurality of interleaved memory units is a minimum subset of said plurality of interleaved memory units that can support said bandwidth.

19. The data transfer system of claim 11, wherein said plurality of interleaved memory units comprise flash memory units.

20. The data transfer system of claim 11, wherein said plurality of interleaved memory units comprise NAND flash memory units.
